(19) United States
(12) Patent Application Publication
(10) Pub. No.: US 2015/0343949 A1
(43) Pub. Date: Dec. 3, 2015

(54) REVERSING CAMERA INCORPORATED INTO THE LOGO

(71) Applicant: RENAULT S.A.S., Boulogne-Billancourt (FR)

(72) Inventors: Laurent Portier, Versailles (FR); Florent Paurd, Paris (FR); Philippe Convers, Montigny Le Bretonneux (FR)

(73) Assignee: RENAULT S.A.S., Boulogne-Billancourt (FR)

(21) Appl. No.: 14/401,391

(22) PCT Filed: Apr. 30, 2013
(86) PCT No.: PCT/FR2013/050954

§ 371 Date: Mar. 12, 2015

(30) Foreign Application Priority Data
May 16, 2012 (FR) 1254532

(51) Int. Cl. B60R 1/00; B60R 13/00; B60R 11/04; H04N 7/18; H04N 5/225

(52) U.S. Cl. CPC B60R 1/00; H04N 7/183; H04N 5/2251; B60R 11/04; B60R 13/005; B60R 2300/8026

(57) ABSTRACT

A reversing camera for a motor vehicle arranged on a rear of the vehicle within a trim element such as a logo, and the camera lies flush with the plane of bodywork of the vehicle. The field of view of the camera is not hampered by the element on which it is placed and everything to the rear of the vehicle can be seen.

The present invention relates to a reversing camera for a motor vehicle and the vehicle provided with said camera.

When parking, motor vehicle drivers need to ascertain the distance which remains between the rear fender or bumper and a potential obstacle which is not visible in the rear view mirror. To achieve this, several solutions have been considered: adding an additional rear view mirror at the rear, placing a sensor which beeps increasingly rapidly when the fender approaches the obstacle or placing a reversing camera which permits the driver to see what lies behind their vehicle.

However, these different devices require equipment which may prove to be unattractive (“lumps”) or which may be in locations where the field of view is limited such as for example below a logo, below a handle, in the bottom of the rear window, in the fender above the license plate or in the license plate light.

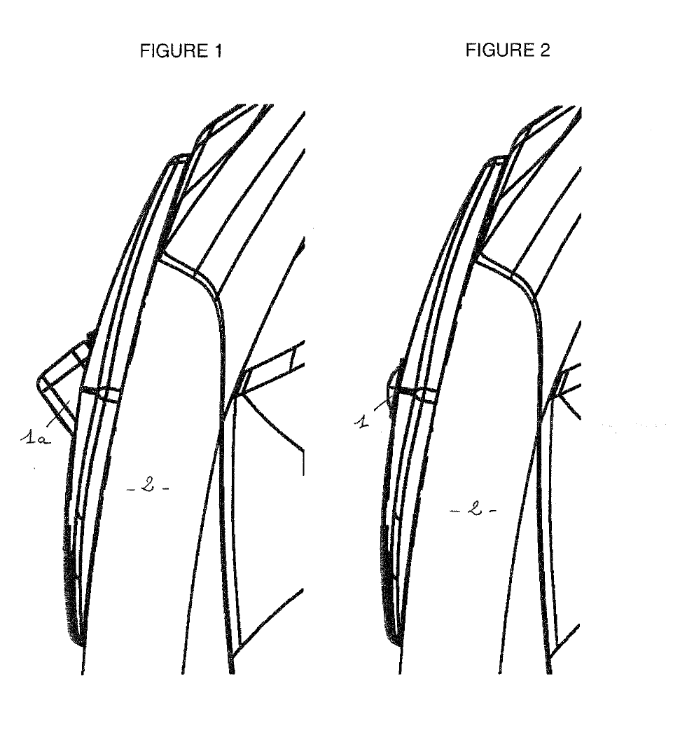

In particular, reversing cameras as shown in FIG. 1 are oriented downwardly with a principal axis of 45° relative to the vertical and in order to provide a correct view said reversing camera has to protrude from the bodywork.

The subject of the invention is to propose a device for arranging a camera which makes it possible to see a large horizontal viewing angle of approximately 180°, and 120° in the vertical direction, which also permits the rear fender to be seen whilst respecting the external appearance of the vehicle and which is less susceptible to dirt from the road.

The device for arranging a camera and an external trim element according to the invention is for a motor vehicle, said camera being arranged inside said element and said camera being flush relative to the plane of the bodywork of the vehicle. Thus, the field of view of the camera is not hampered by the element on which it is placed and permits everything at the rear of the vehicle to be seen. This arrangement is particularly suitable for a vehicle having a license plate on the fender. The camera may also be located on one side so that the driver is able to see what is happening on the other side, i.e. for example in the case of a Japanese motor vehicle with right-hand drive, in order to see the front left-hand side.

The trim element could also be a handle or a logo.

According to a particular feature, the principal axis of the camera is substantially horizontal. The advantage of this feature is that the projection of dirt from the ground is limited.

According to a further feature, the camera has a field of view which incorporates a portion of at least one external trim element which protrudes relative to the bodywork. Thus the camera is able to “see” if said protruding element is liable to come into contact with anything and thus enables the driver to avoid damaging their vehicle.

According to a further feature, the plane of the trim element is upwardly inclined. The top is defined by the upper part of the vehicle. The upward inclination facilitates the arrangement of the camera in an external trim element and provides a greater choice for the person skilled in the art to position the camera without distorting the esthetic appearance of this element.

According to a further feature, the camera is of the wide-angled type. Thus, the field of view of the camera is panoramic, which also permits the rear sides of the vehicle to be seen. The camera may also have high resolution. The driver is thus able to distinguish the details of objects located to the rear of the vehicle, even the smallest of objects.

According to a further feature, the camera is pivoted by 90° about the optical axis and is realigned by 90°. However, for cameras having a field of view which is greater in the horizontal direction (in the case of a wide-angled camera 180° rather than 120°), it may be important to have a large vertical view so that the driver is able to see objects on the ground in order to avoid driving over said objects. In this case the filmed image is pivoted by 90° so that the image reproduced corresponds to what the driver has to see.

According to a particular feature, the camera is fixed in a decorative element such as a logo. The mounting is simpler as the assembly is mounted in one operation when the element is mounted. This solution has the advantage of using standard bodywork since the fixings on the vehicle of the variant without a camera are preserved in the variant with a camera. For the variant with a camera, a simple opening is added to the bodywork as well as clips on the logo.

The camera may also be fixed to the trunk. This position is a good compromise: it is sufficiently high to have an overall view and sufficiently low to see where the wheels are able to travel. This solution is possible in a simple manner when the license plate is placed on the trunk above the fender.

The camera may also be fixed to the fender. The camera is placed at a lower position but as this part of the vehicle is fixed it is not necessary to provide a long connecting cable to the camera, as in the case of the trunk where the trunk opens and carries the camera therewith.

According to a particular feature, the invention comprises a means for selecting the image. The image displayed to the driver is selected in order to show what is of interest.

The invention further relates to the motor vehicle provided with a reversing camera described above.

The principle of this camera could naturally be used in the same manner at the front or on one side without departing from the scope of the invention.

Further advantages could also become apparent to the person skilled in the art by reading the examples below, illustrated by the accompanying figures and provided by way of example.

FIG. 1 shows a profile view of the rear of a vehicle provided with a reversing camera from the prior art,

FIG. 2 shows a profile view of a camera according to the invention,

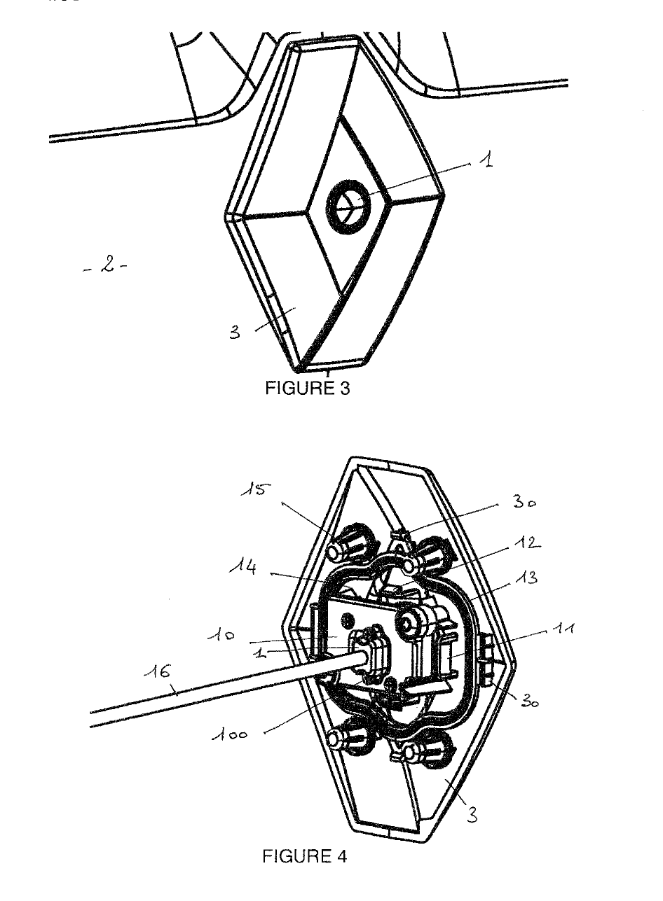

FIG. 3 shows a rear view of the logo provided with the camera,

FIG. 4 is a view of the part concealed by the logo,

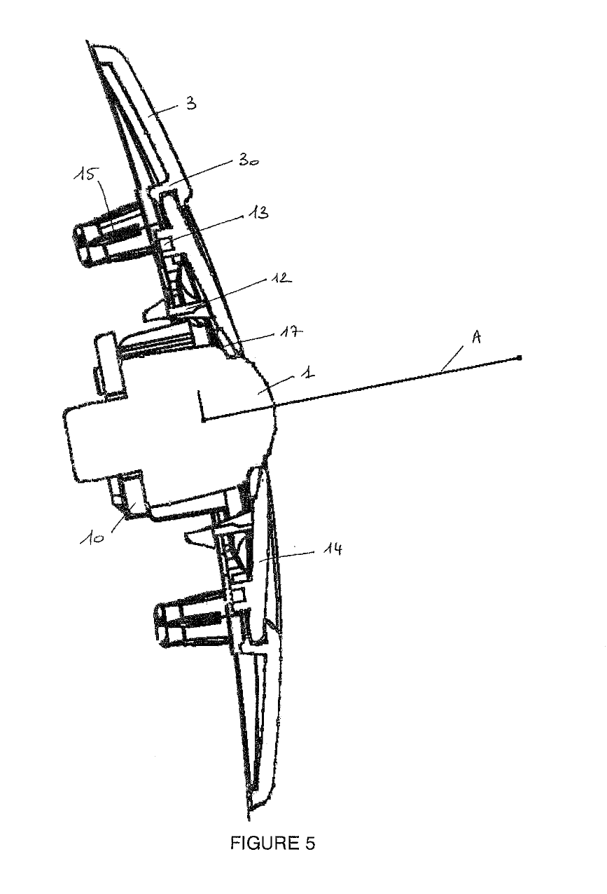

FIG. 5 is a section of the camera according to the invention,

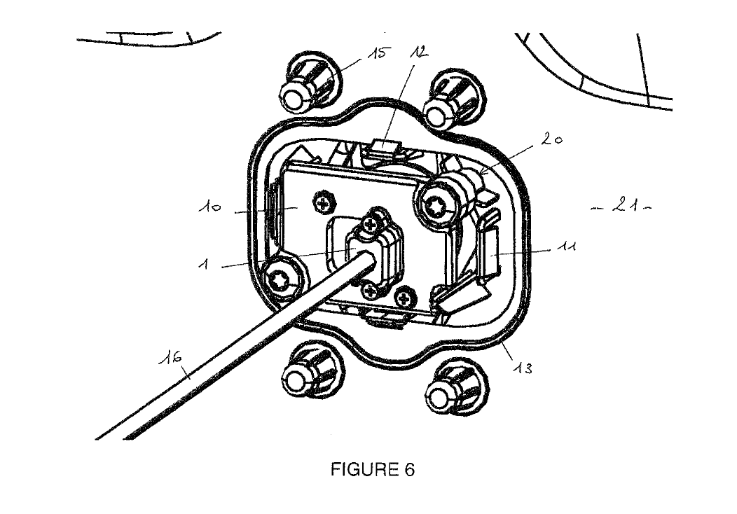

FIG. 6 is a view of the inside of the trunk of the assembly composed of the logo and the camera,

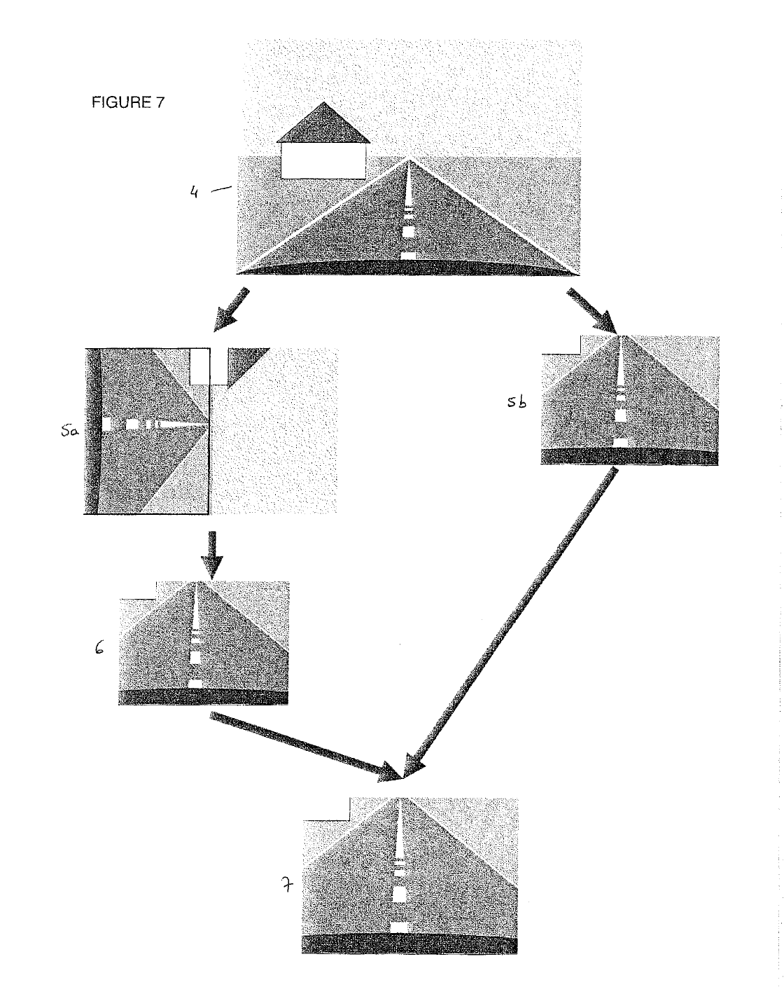

FIG. 7 is an illustration of the adaptation of the image.

The camera la of an example from the prior art is a directional camera with an optical axis (A) or principal axis, the field of view thereof being relatively narrow and targeting the rear lower part of the vehicle 2, and thus it has to protrude relative to the bodywork at the rear of said vehicle 2 which is unattractive in the region of the line of the vehicle. This camera also has to be fixed to the vehicle 2, as the protruding part is quite bulky, and the fixing requires a recess in the bodywork which is both specific and quite large.

In contrast, the camera 1 of the invention is flush with the plane of the bodywork of the vehicle 2 (the surface thereof) as visible in FIG. 2. Thus, the external surface of the bodywork is continuous, which does not alter the line of the vehicle.

The camera 2 is arranged in an external trim element, such as a bodywork part or a decorative element, in this case a logo 3 representing the brand name of the manufacturer. In this case, the camera 2 is placed in the center but it could equally be placed at a different location which is more suitable or more “discrete” esthetically so as not to distort the logo.

As shown in FIG. 5, the camera 2 is fixed to an external trim element (in this case the logo 3), having an upwardly inclined surface. By the term “upwardly” is understood that, when the external trim element is fixed to the vehicle, the line perpendicular to this surface is offset at an angle relative to the horizontal plane and this perpendicular line is above the horizontal plane. Thus, the principal optical axis of the camera 2 is above the horizontal plane, which has the advantage of limiting the projection of dirt or mud from the road.

The camera 1 is fixed to an intermediate support 10 by screws 100. The intermediate support 10 is clipped to a support 14 by four clips 11, two clips being placed laterally and one lower clip and one upper clip. The support 14 is clipped directly to the logo 3 as visible in FIG. 3 by means of four clips 30 (two laterally, and one at the top and one at the bottom). A gasket 13 is placed between the support 14 and the logo 3 to ensure a seal in order to protect the electrical part of the camera from water (rain or projected objects when moving) which could come into contact with the vehicle. This gasket 13 may be produced from EPDM. A gasket 17 is also placed between the camera 1 and the support 14.

The assembly is then placed on the rear of the vehicle 2 by means of clipping studs 15 which pass through the wall 21 of the vehicle 2 and two clips 12 which are attached to the edge of the hole 20 in the wall 21 (see FIG. 6).

The camera 1 is connected to the instrument panel of the vehicle 2 by a connecting cable 16.

FIG. 7 shows the process of reproducing the image from the camera 1 to the driver. The image 4 shows the initial scene in which the vehicle 3 travels.

In a first variant, the camera 1 records the image 5b if it is a standard camera and reproduces the same image 7 to the driver.

In a second variant where the camera 1 is panoramic or wide-angled, the camera 1 is rotated by 90° about its principal optical axis and films the image 5a. The image is processed so as to select the appropriate part of the image and to realign the result obtained so that the driver receives the image 7.

1-10. (canceled)

11. A device for arranging a camera and an external trim element for a motor vehicle,
wherein the camera is arranged inside the external trim element and the camera is flush relative to the plane of the external trim element.

12. The device for arranging a camera as claimed in claim 11, wherein the camera includes an optical axis or principal axis which is substantially horizontal.

13. The device for arranging a camera as claimed in claim 11, wherein the camera has a field of view that incorporates a portion of at least one external trim element that protrudes relative to bodywork.

14. The device for arranging a camera as claimed in claim 11, wherein the plane of the trim element is upwardly inclined.

15. The device for arranging a camera as claimed in claim 11, wherein the camera is of wide-angled type.

16. The device for arranging a camera as claimed in claim 12, wherein the camera is pivoted by 90° about the optical axis and is realigned by 90°.

17. The device for arranging a camera as claimed in claim 11, wherein the camera is fixed in a decorative element.

18. The device for arranging a camera as claimed in claim 11, comprising a means for selecting the image.

19. The device for arranging a camera as claimed in claim 17, connected to the decorative element by at least one gasket.

20. A motor vehicle comprising a device for arranging a camera as claimed in claim 11.
